(19) United States
(12) Patent Application Publication
(10) Pub. No.: US 2010/0114464 A1
(43) Pub. Date: May 6, 2010

(54) SMART TRACTOR INCLUDING COMMUNICATION SYSTEM AND ENGINE STARTING SYSTEM

(75) Inventors: Michael Miller, Sussex, WI (US); Richard Zeckmeister, Brookfield, WI (US); Marv Klowak, Germantown, WI (US); Jason Hansen, Elkhorn, WI (US); Daniel Brueck, Brookfield, WI (US); Robert Koenen, Pewaukee, WI (US)

Correspondence Address: Andrus, Sceales, Starke & Sawall, LLP, 100 East Wisconsin Avenue, Suite 1100, Milwaukee, WI, 53202, US

(73) Assignee: BRIGGS AND STRATTON CORPORATION, Wauwatosa, WI (US)

(21) Appl. No.: 12/609,221

(22) Filed: Oct. 30, 2009

Related U.S. Application Data
(60) Provisional application No. 61/110,157, filed on Oct. 31, 2008.

(51) Int. Cl. F02D 45/00

(52) U.S. Cl. 701/113

(57) ABSTRACT

An engine control, communication and starting system for outdoor power equipment that has a controller and a one or more safety interlocks. The controller monitors the status of the safety interlocks to determine whether the internal combustion engine can be started upon activation of a starting device. If the starting device is activated and one or more of the safety interlocks is in a condition that prevents operation of the engine, the controller generates a feedback message to the operator through a feedback system. The feedback message can be either an audible or visual message that relays information to the operator. The system further includes a speed selection circuit that allows the operator to select the desired engine speed. The controller operates the internal combustion engine at the selected engine speed. During engine operation, the controller terminates operation of the engine if any of the safety interlocks move to an un-allowed status.

### CROSS-REFERENCE TO RELATED APPLICATION

The present application is based on and claims priority to U.S. Provisional Patent Application Ser. No. 61/110,157 filed on Oct. 31, 2008.

### FIELD OF THE DISCLOSURE

The present disclosure generally relates to a communication, control and push-button starting system for use with outdoor power equipment, such as a riding lawn tractor. More specifically, the present disclosure relates to a communication system that visually or audibly communicates with an operator and a starting system that controls the operation of the engine within the lawn tractor based upon operator input or electronic engine monitoring.

### BACKGROUND

Currently available outdoor power equipment, such as lawn tractors, include a safety system that prevents operation of the lawn tractor and terminates rotation of a mowing blade under certain conditions. As an example, current safety systems prevent starting of the engine when the operator is not seated within the lawn tractor driver's seat. As another example, the lawn tractor cannot start when the mowing blade is engaged or when the brake for the tractor is disengaged. Various other safety systems exist in currently available lawn tractors to prevent starting or to kill the operation of the engine and stop rotation of the mowing blade upon certain conditions being met.

Although these types of safety systems are familiar to operators that have experience in operating lawn tractors, novice operators are oftentimes unable to determine why the engine of the lawn tractor will not start when the ignition key is turned. In currently available lawn tractors, if the user is not sitting in the seat when the ignition key is turned, the engine simply will not start. Likewise, if the ignition key is turned and the mowing blade is engaged, the engine is disabled from starting and running without providing any feedback to the operator as to why the engine did not start. For many novice operators, the inability to start the engine upon turning the ignition key leads to significant frustration.

In addition to the inability to determine why an engine will not start, novice users also experience difficulty in determining how long the ignition key needs to be held in the starting position to crank the engine. Oftentimes, novice users will hold the ignition key in the starting position less than the time required to start the engine. Alternatively, if the engine will not start, the novice user may hold the ignition key in the starting position for an extended period, which may be well after the normal amount of time required to start the engine. Thus, novice users are often frustrated by the inability to start a lawn tractor, which leads to apprehension in using the tractor.

### SUMMARY

The present disclosure provides a communication, control and push-button starting system for the internal combustion engine of outdoor power equipment, such as but not limited to a lawn tractor. The engine control and starting system detects the status of one or more safety interlocks and initiates operation of the internal combustion engine only upon the safety interlocks being in a desired position. If the engine does not start because of one of the safety interlocks, the system of the disclosure generates a feedback message to the operator that indicates the reason the engine did not begin operation.

The system of the present disclosure includes a controller that is coupled to a plurality of safety interlocks. Each of the safety interlocks generates a safety signal based on the status of the safety interlock. Based upon the safety signals received by the controller, the controller determines whether operation of the internal combustion engine is allowed. As an illustrative example, the safety signal from each of the safety interlocks must meet a specific status requirement for the controller to allow operation of the internal combustion engine.

If the controller determines that all of the safety signals from the safety interlocks do not meet the required status conditions, the controller will generate a feedback message to the operator through a feedback system. The feedback system may include either a speaker or a visual display, or both. The feedback message generated by the controller will then be relayed to the operator either through the speaker or the visual display. In this manner, the operator is provided with information as to the reason why the engine would not start upon activation of a starting device.

In one embodiment of the disclosure, the starting device coupled to the controller is a push button. When the push button is depressed, the controller initiates operation of the internal combustion engine if, and only if, the safety interlocks generate the required safety signals indicating the status of the safety interlocks are such as to permit engine operation.

The engine control and starting system of the present disclosure further includes a speed selection circuit that is coupled to the controller. The speed selection circuit allows the operator to select the desired operating speed for the internal combustion engine. In one embodiment, the speed selection circuit includes a plurality of speed buttons that are each associated with a desired speed. By depressing one of the speed selection buttons, the operator can indicate the desired speed for the lawn tractor.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### BRIEF DESCRIPTION OF THE DRAWINGS

The drawings illustrate the best mode presently contemplated of carrying out the disclosure. In the drawings:

FIG. 1 is a side view of a riding lawn tractor;

FIG. 2 is a schematic illustration of the communication between a controller of the lawn tractor and various input and output devices for the lawn tractor;

FIG. 3 is a flowchart illustrating the operational steps performed by the controller of the lawn tractor; and

FIG. 4 is a front view of one embodiment of a user interface for the lawn tractor shown in FIG. 1.

### DETAILED DESCRIPTION OF THE DRAWINGS

The present disclosure is generally directed to a communication, control and starting system for use with outdoor power equipment, such as but not limited to a lawn tractor, walk-behind mower, pressure washer, portable electric generator, snow blower or other similar type of equipment. The drawing Figures depict use of the communication, control and starting system for use with one type of outdoor power equipment, namely, a lawn tractor. However, it should be understood that the communication, control and starting system could be utilized with other types of outdoor power equipment while falling within the scope of the disclosure and claims.

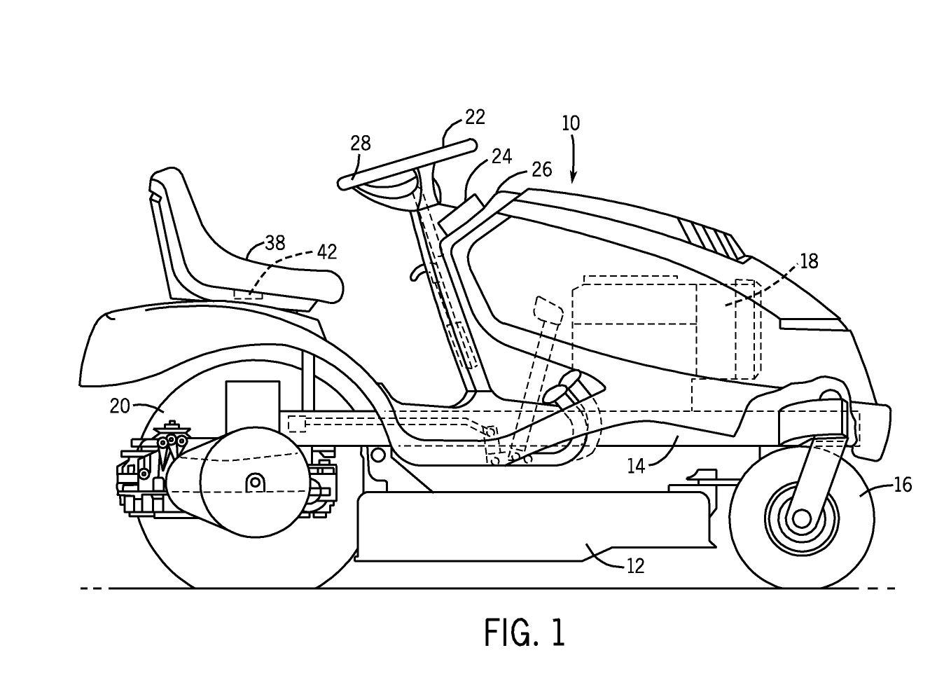

FIG. 1 illustrates a lawn tractor 10 having a mowing assembly 12 mounted beneath a vehicle chassis 14 supported by four wheels 16. The lawn tractor 10 includes an internal combustion engine 18 that powers both the rear drive wheels 20 and a mower blade contained within the mowing assembly 12. The steering assembly 22 allows the operator to control the movement of the lawn tractor 10 as is conventional. The details of the lawn tractor 10 shown in FIG. 1 are meant for illustrative purposes only, since the lawn tractor 10 could have various different operator controls and physical configurations while falling within the scope of the present disclosure. Additionally, although riding lawn tractor 10 is illustrated, the present disclosure could also be used with other types of outdoor power equipment, such as a walk-behind mower or a snow blower.

In accordance with the present disclosure, the lawn tractor 10 includes a user interface 24 shown mounted to the front panel 26. Although the user interface 24 is shown mounted to the front panel 26, it should be understood that the user interface 24 could be positioned at various other locations on the tractor, such as integrated into the front panel 26 or mounted within the steering wheel 28. The location of the user interface 24 is shown in FIG. 1 for illustrative purposes only and should not be deemed limiting to the present disclosure.

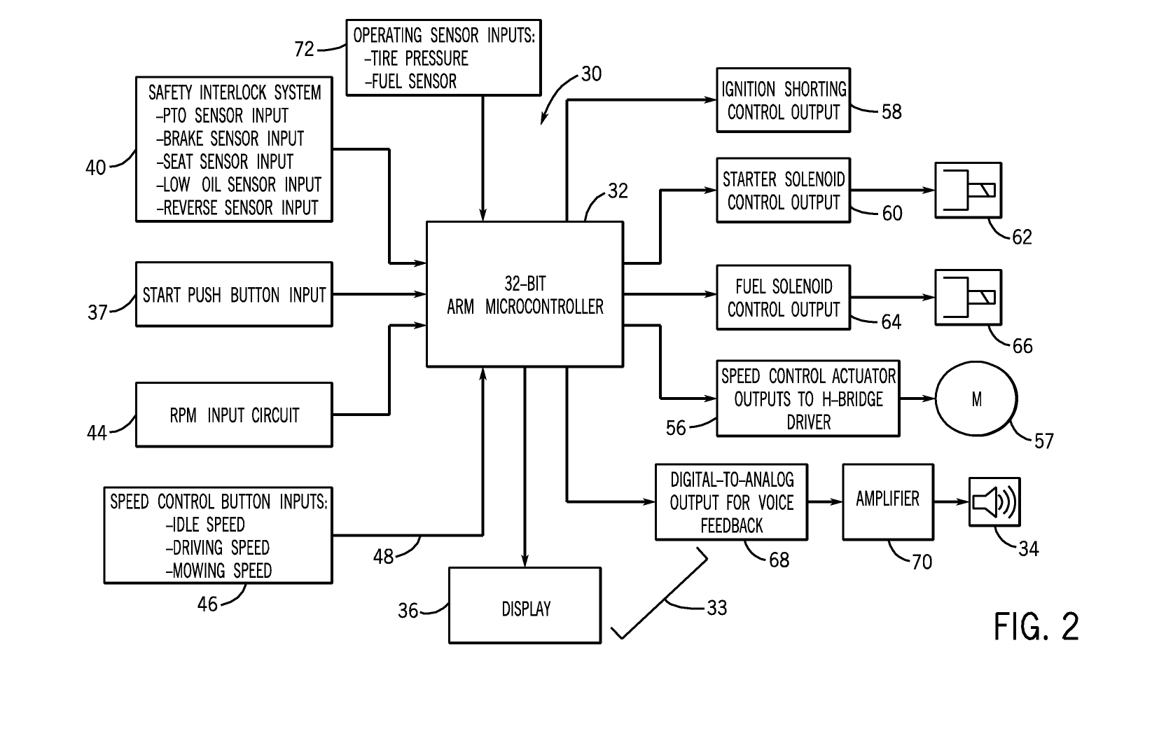

FIG. 2 provides a schematic illustration of an engine control and starting system 30 that forms part of the user interface 24 in accordance with the present disclosure. Although the control and starting system 30 will be described with reference to the present disclosure, it should be understood that the system 30 could be configured to provide additional features and functions while operating within the scope of the present disclosure. Additionally, although a riding lawn tractor 10 is illustrated, the present disclosure could also be used with other outdoor power equipment, such as a walk-behind mower or a snow blower.

The control and starting system 30 shown in FIG. 2 includes a controller 32 that is in operative communication with a series of sensors and operating controls/components of the lawn tractor and provides communication to an operator of the lawn tractor. Set forth below will be various functions that are currently contemplated for the controller 32, although others are contemplated.

### Problems/Safety Functions

As described previously, safety systems within the lawn tractor 10 prevent operation of the internal combustion engine 18 when certain conditions are not met, such as when the mowing blade is engaged or the brake is disengaged upon initial startup. The controller 32 is provided to communicate the reasons for the inability to start the internal combustion engine to the operator through a feedback system 33, which can include a speaker 34 and/or a display 36, or both.

As illustrated in FIG. 2, the controller 32 is in operative communication with various different components of the lawn tractor. The controller 32 is coupled to a safety interlock system 40 that includes various different safety interlocks for the lawn tractor. In the embodiment illustrated, the safety interlock system 40 includes a PTO sensor, a brake sensor, a seat sensor, a low oil sensor and a reverse sensor. Although these safety interlocks are shown in the embodiment of the disclosure shown in FIG. 2, it should be understood that various other safety interlocks could be utilized while operating within the scope of the present disclosure.

Each of the safety interlocks generates a safety signal based on the operation status of the safety interlock. The safety signals are received at the controller 32. As an example, a seat sensor 42 shown in FIG. 1 is positioned beneath the driver's seat 38 and generates a safety signal that is received at the controller 32. If an operator is present in the driver's seat 38, the seat sensor 42 detects this presence and provides a safety signal to the controller indicating the presence of an operator, which ultimately allows the engine to begin operation. If the seat sensor 42 does not sense the presence of an operator, the seat sensor 42 generates a safety signal indicating that an operator is not present on the seat 38.

The various other safety interlocks shown in the safety interlock system 40 provide similar safety signals to the controller 32. For example, the brake sensor provides a safety signal indicating the depression of the brake; the low oil sensor generates a safety signal indicating an acceptable or unacceptable level of oil; the PTO sensor generates a safety signal indicating the status of the PTO; and the reverse sensor generates a signal indicating whether the tractor is in reverse.

The controller 32 is also connected to a starting device 37. In the embodiment shown, the starting device is a push button that can be depressed by an operator to indicate that the operator wishes to start operation of the internal combustion engine. However, it is contemplated that various other types of starting devices 37, such as a typical keyed ignition switch, could be utilized while operating within the scope of the present disclosure.

The controller 32 is further connected to an RPM input circuit 44 that monitors the status of the internal combustion engine and provides an RPM signal to the controller 32. The RPM input circuit 44 allows the controller 32 to determine whether the internal combustion engine is operating, the significance of which will be discussed in detail below.

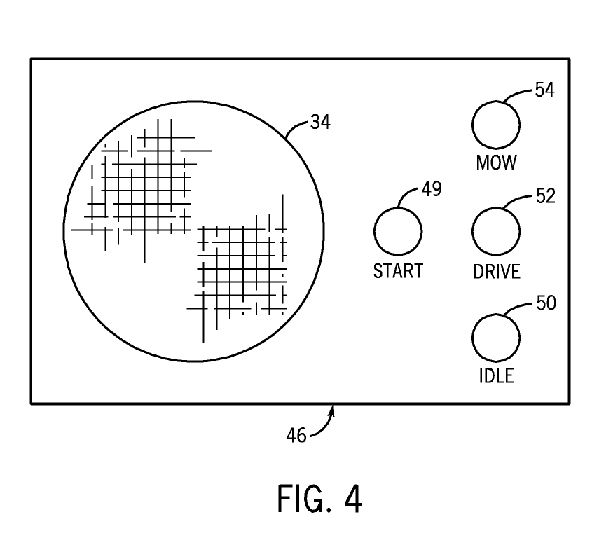

The controller 32 further receives input from a speed selection circuit 46. The speed selection circuit 46 generates a speed signal along line 48 to provide an input to the controller 32 indicative of the desired speed for the lawn tractor. In the embodiment illustrated in FIG. 4, the speed selection circuit 46 includes three separate speed selection buttons that allow the operator to select the desired speed for the lawn tractor. In the embodiment of FIG. 4, the speed selection circuit 46 includes an idle speed button 50, a drive speed button 52 and a mow speed button 54. In the embodiment shown in FIG. 4, the engine speed button 50 corresponds to an idle speed for the engine, engine speed button 52 corresponds to a driving speed for the engine, while engine speed button 54 corresponds to a mowing speed for the engine.

When the operator depresses any one of the three engine speed buttons 50, 52 and 54, this information is received at the controller 32. The controller 32, in turn, relays this information to a speed control actuator 56. The speed control actuator 56 controls the actuation of a motor 57 that adjusts the position of the throttle within the internal combustion engine 18 to operate the engine at the speed selected by the operator through depression of one of the engine speed buttons 50, 52, 54.

Although three engine speed buttons 50, 52 and 54 are shown in FIG. 4, various other types of engine speed controls could be utilized while operating within the scope of the present disclosure. As an example, the engine speed buttons could be replaced by up/down arrows that allow the operator to depress the desired arrow depending upon whether the operator wishes to increase/decrease the engine speed. Alternatively, the engine speed buttons could be replaced by a touch screen display that allows the operator to depress a visual representation of various engine speeds on the display. In each case, the speed selection circuit 46 provides a speed signal to the controller 32 such that the controller can adjust the operating speed of the internal combustion engine as desired.

In the embodiment shown in FIG. 2, the speed selection circuit 46 replaces the manual speed selection lever found in many currently available lawn tractors. As an example, the speed selection circuit 46 can include an electronically activated solenoid that adjusts the position of the cable connected through a linkage assembly to the throttle for the internal combustion engine. Thus, the engine speed buttons 50, 52 and 54 replicate the various positions of a manual speed control lever currently utilized by many lawn tractors.

Based upon the selection of one of the three engine speed buttons 50, 52 and 54, the speed selection circuit 46 provides a speed signal to the controller 32, which in turn adjusts the engine speed to different ranges corresponding to each of the selected engine speeds. As an example, the engine speed during idle conditions may be between 2200 RPM and 1200 RPM while the engine speed during mowing conditions could be between 2000 and 4000 RPM. The controller 32 receives actual engine speed information from the RPM input circuit 44. Based upon the engine speed information from the input circuit 44, the controller 32 continues to provide signals to the speed control actuator 56 to adjust the engine speed as desired.

In the embodiment described above, the speed control actuator 56 includes an electronically operated solenoid that performs the function of a manual control lever in currently available lawn tractors. However, it is contemplated that the speed control actuator 56 could also be directly connected to the throttle of the internal combustion engine. In such a system, the controller 32 would directly adjust the position of the throttle to achieve the desired engine speed based upon an operator input.

In many internal combustion engines utilized with lawn tractors, a mechanical governor is used to control the engine speed. However, in some instances, the position of a mechanical speed control lever prevents the governor from opening the throttle sufficiently to achieve a desired engine speed. In the system shown in FIG. 2, the controller 32 utilizes the motor 57 to adjust the position of the throttle plate. Thus, the system shown in FIG. 2 allows the engine speed to be electronically adjusted rather than based solely upon a mechanical linkage.

In the embodiment shown in FIG. 4, the speed selection circuit 46 includes three engine speed buttons that allow the operator to control the speed of the engine. However, it is contemplated that the speed of the engine could be controlled without utilizing any input selection from the user. As an example, sensors can be positioned within the engine that sense the load on the engine due to the mowing blades contacting grass. Specifically, when the mowing blades contact grass, the load on the engine increases, thus at least initially decreasing the engine speed. When the controller senses the decrease in engine speed, the controller can control the position of the throttle through the speed control actuator 56 to increase the engine speed to the mowing speed. Likewise, if the tractor is no longer mowing grass, the load on the engine will significantly decrease. Upon the decrease in the load on the engine, the control unit can increase the engine speed to the driving speed. In this manner, the control unit can operate the engine without requiring the operator to select either the mowing speed or the driving speed.

In addition to adjusting between a mowing speed and a driving speed, the system of the present disclosure could also include controls that would allow the operator to adjust the speed of the engine when the engine is at either the mowing or driving speed selection. As an example, the user could initially select the mowing speed through engine speed button 54, which will cause the controller to operate the engine at a predetermined speed. Additional buttons could be included on the speed selection circuit 46, such as an up and a down arrow, that allow the operator to increase or decrease the engine speed from the predetermined mowing speed. As an example, if the preselected engine speed for the mowing selection is 3000 RPMs, the operator could depress either the up or down arrows to adjust this speed to as low as 2000 RPMs or as high as 4000 RPMs. This operator adjustment allows more sophisticated operators to have greater control on the engine speed based upon the current cutting conditions. However, the maximum and minimum engine speed for each of the idle, drive and mowing selections would be limited based upon preselected values assigned within the controller.

Referring back to FIG. 2, the controller 32 is also shown connected to various other operating components within the lawn tractor such that the controller 32 can carry out additional functions. As illustrated, the controller 32 is connected to an ignition shorting control output 58 that allows the controller 32 to terminate operation of the internal combustion engine by shorting the ignition coil of the engine and thus preventing operation of the spark plugs.

The controller 32 can generate a starter solenoid control output signal 60 to a starter solenoid 62. The starter solenoid control output 60 to the starter solenoid 62 controls cranking of the internal combustion engine.

The controller 32 can generate a fuel solenoid control output 64, which in turn is received by the fuel solenoid 66. Through the fuel solenoid control output 64, the controller 32 can control the operation of the fuel solenoid 66.

The controller 32 is connected to the speaker 34 through a digital-to-analog converter 68 that converts a digital feedback signal from the controller 32 into an analog signal that is played through the speaker 34 after amplification by the amplifier 70.

In addition to the speaker 34, the controller 32 can also relay the same feedback signal to the operator through a display 36. The display can be any type of display, such as an LED screen, that can display information and graphics. Thus, the operator can learn either through audible messages or a visual display the reason why the engine will not start upon activation of the ignition circuit.

Finally, the controller 32 is connected to an operating sensor input circuit 72 that provides various operating sensor signals to the controller 32. In the embodiment illustrated, the operating sensor inputs include a tire pressure sensor, a fuel sensor as well as various other sensors that relay the operational status of the lawn tractor.

### Starting and Speed Control

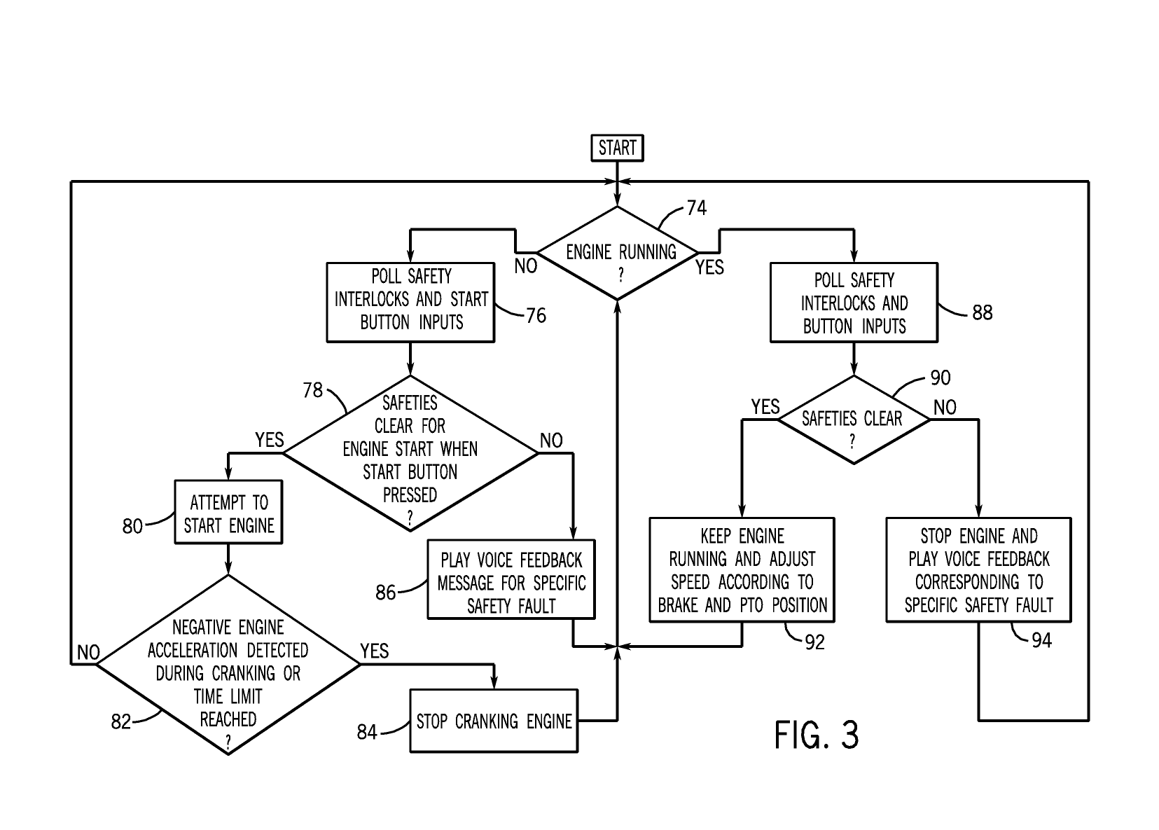

FIG. 3 illustrates the general operating steps performed by the controller 32 of the engine control and starting system 30. Although these steps are shown, it should be understood that other steps could be utilized while operating within the scope of the disclosure. As illustrated in step 74, the controller initially determines whether the internal combustion engine of the lawn tractor is running. The controller 32 makes this determination by sensing the engine RPMs through the RPM input circuit 44 shown in FIG. 2.

If the controller determines that the engine is not currently running, the controller 32 polls each of the plurality of safety interlocks that form part of the safety interlock system 40. During this polling in step 76, the controller determines the current status of each of the plurality of safety interlocks. In addition to polling each of the safety interlocks, the controller checks for the presence of the start signal from the starting device, which in the embodiment illustrated is a push button.

After the controller has checked the status of the safety interlocks and the start button, the controller determines in step 78 whether the starting device has been actuated. In step 78, if all of the safety interlocks provide the required status signals indicating that the safety interlocks are each in a condition to allow engine starting, the controller attempts to start the engine in step 80. As an example, if the controller determines in step 78 that the seat is occupied, the brake is depressed, the low oil sensor detects the required oil level and the reverse sensor indicates that the tractor is not in reverse, the controller is satisfied and the engine can be started. If any one of the safety interlocks generates a safety signal indicating that the status of the safety interlock is not correct to allow engine operation, the controller will prevent engine operation, as will be described. The controller attempts to start the engine by generating the starter solenoid control output 60 to the starter solenoid 62, shown in FIG. 2.

In step 82, the controller determines whether negative engine acceleration is detected during cranking or whether the time limit for cranking has been reached. If neither of these two conditions are met, the system returns to step 74 to determine whether the engine is currently running and the controller continues the process.

If, in step 82, the controller determines that the time limit has been reached or negative engine acceleration was detected, the system stops cranking the engine in step 84 and returns to step 74 to determine whether the engine is currently running.

Referring back to step 78, if the controller determines that at least one of the safety interlocks is not in the required condition to allow engine starting when the start button is pressed, the controller generates a feedback message to the operator. In the embodiment illustrated in FIG. 3, the feedback message from the controller is an audible message, as illustrated in step 86. The audible message generated in step 86 is fed to the digital-to-analog converter 68 and ultimately to the speaker 34 through the amplifier 70, as shown in FIG. 2. As an example, one of the safety interlocks of the safety interlock system 40 shown in FIG. 2 is a seat sensor. If the operator is not in the seat of the lawn tractor when the operator attempts to start the engine, the controller determines in step 78 that the engine cannot start due to the status of the seat sensor 42. When the controller 32 detects this situation, the controller generates a feedback message that is an audible message conveyed through the speaker 34 audibly explaining the reason for the failure to start the engine. As an example, the controller 32 could generate a feedback message stating “driver's seat unoccupied”.

Upon hearing such an audible message, the operator can then be seated in the driver's seat 38, which will close the seat sensor 42 and allow the engine to start. The controller can generate similar feedback signals depending upon the safety interlock status that will not allow the engine to start. It is contemplated that the controller 32 will generate a feedback signal for each of the safety interlocks that are not in the required condition to allow engine starting. In this manner, the controller can audibly relay feedback messages to the operator telling the operator the reason the engine does not start.

In addition to the seat sensor 42, the controller 32 is also connected to a brake sensor. Thus, if the operator attempts to start the lawn tractor when the brake is not applied, the controller 32 will generate an audible message through the speaker 34 indicating that the brake has not been applied. A cutting blade sensor is also connected to the controller 32 such that should the operator attempt to start the tractor when the mowing blade is engaged, the controller 32 will generate an audible message through the speaker 34 indicating to the operator that the mowing blade is engaged. An oil sensor relays information regarding the oil level within the engine to the control unit. Since the engine will not start when the oil level from the oil level sensor is below a threshold value, the controller 32 generates an audible message through the speaker 34 to the operator indicating that the engine will not start due to the low oil level.

Although the embodiment of FIG. 3 is described as generating audible feedback messages, it should also be understood that the feedback messages could be generated to the display 36 to provide a visual feedback message to the operator as well as the audible message described above.

In this manner, the engine control and starting system for the lawn tractor provides audible feedback to the operator regarding the reasons the engine of the lawn tractor will not start. Such a system allows the operator to be placed at ease when the engine will not start upon the operator activating the starting device.

Referring back to FIG. 3, if the controller determines that the engine is running in step 74, the controller once again polls the safety interlocks and start button input in step 88. If the controller determines that the safety interlocks are clear in step 90, the system will then check for the engine speed input from the engine speed selection circuit 46. Based upon the speed button depressed on the speed selection circuit 46, the controller keeps the engine running and adjusts the speed according to the brake and PTO positions, as illustrated in step 92.

If, however, the safety interlocks are not clear in step 90, the controller generates a signal to short the ignition of the internal combustion engine, which stops operation of the internal combustion engine, as illustrated in step 94. In addition to stopping engine operation, the controller generates a feedback message which, in the embodiment of FIG. 2, is played through the speaker 34. The feedback message again provides a specific audible message to the operator indicating the reason engine operation was terminated in step 94. As an example, if the seat is no longer occupied, the controller 32 will generate a message stating “driver's seat unoccupied”. In this manner, the controller signals to the operator the reason the engine operation was terminated, which allows the operator to change their position and restart the engine.

As described above, the controller 32 shown in FIG. 2 provides audible messages through the speaker 34 to an operator to indicate to the operator various operating conditions that prevent the starting of the internal combustion engine. These audible messages are particularly comforting to a novice operator who may be unclear as to why the internal combustion engine will not start upon either depression of the start button 49 shown in FIG. 4 or upon activation of a conventional key ignition switch. The audible message is relayed to the operator to provide the operator with enhanced comfort in operating the lawn tractor 10.

### Maintenance Functions and Instructions

Referring back to FIG. 2, the controller 32 can also be configured to receive other information from sensors positioned within the lawn tractor 10 and generally grouped in the operating sensor input circuit 72. Thus, the controller 32 can generate various types of message through the speaker 34 and the display 36 regarding the operation and maintenance for the lawn tractor. As an example, an oil sensor can relay information to the controller regarding the oil level currently in the tractor or information regarding the last time the oil was changed by the operator. It is contemplated that the controller 32 could receive operating information from the internal combustion engine such that the controller 32 provides indications to the user when to change the oil based upon the operating time since the last oil change. Further, it is contemplated that the controller 32 could calculate the oil life remaining based upon usage profiles of the internal combustion engine. As an example, if the controller 32 determines that the engine has been operated under heavy load conditions, such as due to cutting thick/wet grass, the controller 32 could indicate to the operator to change oil sooner than standard manufacturers oil life standards. Likewise, if the tractor 10 is used in light load conditions, the life of the oil may be extended based upon information from the internal combustion engine.

A fuel sensor can also communicate to the controller 32 such that the controller 32 can provide either an audible indication to the user or a visual indication to the user as to the level of fuel remaining in the gas tank.

An air filter sensor and a fuel filter sensor can communicate to the controller 32 such that the controller can advise the operator when either the air filter or the fuel filter need to be replaced. A tire pressure sensor could be utilized to communicate the current tire pressure, which the controller 32 can display to the operator or provide an audible message as to a low tire pressure condition.

In the embodiment shown in FIG. 2, the controller 32 is positioned to receive information from various different sensors either already included in the lawn tractor 10 or added in accordance with the present disclosure. The controller 32 receives the information from the various sensors in the lawn tractor and communicates information/instructions to the operator through either the speaker 34 or the display 36. In this manner, the controller 32 provides additional information to the operator concerning the operation of the lawn tractor.

Although the controller 32 has been described as simply providing information to the operator as to the current status of the lawn tractor, it is contemplated that the controller 32 could also be operated in a tutorial mode. In such a tutorial mode, the controller could provide instructions to the operator through both the speaker 34 and the display 36 as to how to operate/use the lawn tractor. As an example, the lawn tractor could have a tutorial/begin operation button that the operator depresses upon wanting to start operation of the lawn tractor. Upon depression of the begin button, the controller could relay detailed instructions to the operator how to begin using the product. As an example, the controller 32 could instruct the operator to initially sit on the driver's seat 38, engage the brake and disengage the cutting blade. Once all of these steps were taken, the controller 32 would then instruct the operator to depress the start button 49 to begin operation of the lawn tractor. In this manner, the controller 32 provides detailed instructions to the operator as to the sequence of events that need to take place prior to beginning operation of the lawn tractor.

In addition to instructing the operator how to operate the lawn tractor, the controller 32 could provide information to the operator through the display 36 as to replacement parts needed for the lawn tractor. For example, if the controller 32 determines that the fuel filter needs to be replaced, the controller 32 could provide an audible message to the operator indicating that the fuel filter needs to be replaced. The controller 32 could display the correct part number on the display and even provide an indication to the operator where the nearest dealer is located to obtain the replacement part. The controller 32 could be programmed to include dealer locations near the operator. Such programming would be a benefit to individual dealers/distributors to ensure that genuine parts are purchased from the same dealership where the lawn tractor was purchased.

In addition to the speaker 34, it is contemplated that the input device could include a headphone jack that would allow the communication system to audibly communicate with the operator through a set of headphones. The use of headphones by the operator would allow the tractor/engine to audibly communicate to the operator during engine operation and would overcome the loud noise of the engine and blades. The headphone jack could be included on the user interface 24 or at other easily accessible locations on the tractor.

Although the present disclosure has been shown and described as being used with a lawn tractor, the concepts and ideas described herein could be utilized with other types of the power equipment, such as but not limited to snow blowers, chipper/shredders, push mowers and the like.

We claim:

1. An engine control and starting system for outdoor power equipment, the system comprising:
a plurality of safety interlocks that each generate a safety signal based on the status of the safety interlock;
a controller coupled to the plurality of the safety interlocks to receive the safety signal from each of the safety interlocks, wherein the controller is operable to allow operation of the engine or terminate operation of the engine based upon status of the safety interlocks; and
a feedback system coupled to the controller to provide feedback to an operator, wherein the controller generates a feedback message to the feedback system, the feedback message being based on the safety signals received from the plurality of safety interlocks.

2. The engine control and starting system of claim 1 wherein the feedback system includes a speaker and the feedback message is an audible message played through the speaker.

3. The engine control and starting system of claim 1 wherein the feedback system includes a visual display and the feedback message is a visual message shown on the display.

4. The engine control and starting system of claim 1 further comprising a starting device coupled to the controller, wherein the starting device generates a start signal received by the controller upon activation of the starting device by the user.

5. The engine control and starting system of claim 4 wherein the starting device is a push button.

6. The engine control and starting system of claim 1 wherein the outdoor power equipment is a lawn tractor.

7. The engine control and starting system of claim 6 further comprising a speed selection circuit coupled to the controller to provide a speed signal to the controller, the speed signal indicating a selected speed for the outdoor power equipment.

8. The engine control and starting system of claim 7 wherein the speed selection circuit includes a plurality of speed selection buttons each associated with a desired speed.

9. The engine control and starting system of claim 8 further comprising a speed control actuator coupled between the controller and the internal combustion engine, wherein the controller controls the speed of the engine through the speed control actuator.

10. A method of controlling and starting an internal combustion engine of a lawn tractor, comprising the steps of:
providing a controller for the lawn tractor;
monitoring for the activation of a starting device when the engine is not running;
upon receiving a start signal from the starting device, determining the status of each of a plurality of safety interlocks;
determining in the controller if the status of any of the plurality of safety interlocks should prevent starting of the engine; and
generating a feedback message to the user that details the status of each of the safety interlocks that prevented starting of the engine.

11. The method of claim 10 wherein the feedback message is an audible message.

12. The method of claim 10 wherein the feedback message is a visual message.

13. The method of claim 10 further comprising the step of starting the engine only when the status of none of the plurality of safety interlocks should prevent starting.

14. The method of claim 10 further comprising the steps of:
during operation of the internal combustion engine, checking the status of the plurality of safety interlocks; and
terminating the operation of the internal combustion engine and generating the feedback message to the operator as to the status of each of the safety interlocks that caused the termination of the operation of the internal combustion engine.

15. The method of claim 14 wherein the feedback message is an audible message.

16. The method of claim 14 wherein the feedback message is a visible message.

17. The method of claim 10 further comprising the steps of:
providing the lawn tractor with a speed selection circuit coupled to the controller and having a plurality of speed selection buttons each associated with a desired speed for the lawn tractor;
monitoring for the activation of one of the speed selection buttons; and
providing a speed selection signal from the controller to a speed control actuator to control the speed of the lawn tractor.

18. The method of claim 10 wherein the starting device is a push button.

19. An engine control and starting system for a lawn tractor, the system comprising:
a plurality of safety interlocks that each generate a safety signal based on the status of the safety interlock;
a controller coupled to each of the plurality of safety interlocks to receive the safety signals from each of the plurality of safety interlocks, wherein the controller is operable to allow operation of the engine or terminate operation of the engine based upon the safety signals;
a starting device coupled to the controller, wherein the starting device generates a start signal to the controller upon activation by the user; and
a feedback system coupled to the controller to provide a feedback message to the operator, wherein the controller generates the feedback message to the feedback system regarding the safety signal received from the safety interlocks that prevented starting of the internal combustion engine upon activation of the starting device.

20. The engine control and starting system of claim 19 wherein the starting device is a push button.

21. The engine control and starting system of claim 19 further comprising a speed selection circuit coupled to the controller to provide a speed signal to the controller, the speed signal being indicative of a selected speed for the lawn tractor.

22. The engine control and starting system of claim 21 wherein the speed selection circuit includes a plurality of speed selection buttons each associated with a desired speed for the lawn tractor.
